(19) United States
(12) Patent Application Publication
(10) Pub. No.: US 2007/0281285 A1
(43) Pub. Date: Dec. 6, 2007

(54) Educational Interactive Video Game and Method for Enhancing Gaming Experience Beyond a Mobile Gaming Device Platform

(76) Inventor: Surya Jayaweera, Claremont, CA (US)

Correspondence Address: LOZA & LOZA LLP, 305 N. Second Avenue, #127, Upland, CA, 91786-6064, US

(21) Appl. No.: 11/681,255

(22) Filed: Mar. 2, 2007

Related U.S. Application Data
(60) Provisional application No. 60/803,496, filed on May 30, 2006.

(51) Int. Cl. G09B 19/00; G09B 19/02

(52) U.S. Cl. 434/156; 434/188

(57) ABSTRACT

Interactive educational games are provided that include adventure storylines in which a player advances, scores points, or wins by correctly answering challenges (e.g., questions related to math skills or word construction skills, etc.) posed throughout the game. The game gauges and dynamically adjusts a player's skill and knowledge level for a particular subject (e.g., math, grammar, spelling, science, etc.) to tailor the challenges and/or speed of the game accordingly. As the game progresses, it monitors the player's progress in terms of skill and/or knowledge level and dynamically adjusts the type and/or difficulty of the questions to challenge the player. A centralized website is also provided with a secure authentication method to enable players to report their gaming records and obtain codes that adjust the operation of their game.

### CLAIM OF PRIORITY UNDER 35 U.S.C. § 119

The present application for patent claims priority to Provisional Application No. 60/803,496 entitled “Educational Interactive Adventure Games” filed May 30, 2006 and is hereby expressly incorporated by reference herein.

### FIELD

One feature relates to educational adventure games and, in particular, to multi-player interactive software games having a storyline in which a player advances, scores points, or wins by correctly answering questions (e.g., math skills or word construction skills) posed throughout the game.

### BACKGROUND

The advent of computers, video game machines, and gaming stations has caused children to spend more time playing electronic games. Adventure and action electronic games are particularly popular with children.

It is often the case that children prefer to play these adventure and action games instead of studying subjects such as math, spelling, grammar, etc. This may be because these subjects are often presented in a dry and boring way. Thus, a way is needed to leverage the popularity of adventure and action electronic games to interest children in learning academic subjects.

Additionally, some games may allow multiple players to play against each other, but due to differing skill levels and/or players of different ages such games are not competitive or challenging to some players. Thus, a way is needed to allow players of different ages, skill and/or knowledge levels to compete against each other while each player is challenged according to his/her individual skill and/or knowledge level.

Many conventional games are designed to be played on mobile gaming devices that have limited or not network connectivity. While some mobile gaming devices may communicate with other local gaming devices, they typically cannot communicate over broader networks (e.g., Internet, etc.). As such, their features and gaming experience is limited to the gaming device platform. Consequently, a way is needed to expand the gaming features beyond gaming device platforms.

### SUMMARY

A computer-readable medium is provided having one or more instructions defining an interactive educational action game operational on mobile gaming device. A starting game level (e.g., knowledge and skill levels) for a player is assessed. An immersive storyline is also provided with multiple paths that depend on answers provided by the player to challenges posed throughout the game. The player may assume the role of a character immersed in the storyline. Challenges are posed to the player, wherein the challenges are related to an academic subject matter. For instance, the challenges may be related to at least one of mathematics, vocabulary, grammar, or logic. The storyline in the interactive game is advanced when the player correctly answers a challenge. Different paths of the storyline may be selected according to the correctness of the answers provided to the challenges posed.

A game record (e.g., knowledge and/or skill information) is retained for the player for multiple games based on the challenges posed to the player. The difficulty level of the game levels may be adjusted according to the game record (e.g., knowledge and/or skill information) for the player. The types of challenges presented to the player may be adapted according to the game record for the player to hone a weakness.

A player may be assigned different characters in the storyline as the game progresses. Additionally, the player may select the storyline from a plurality of storylines.

One feature provides for wirelessly linking multiple gaming platforms together to enable a multi-player mode in which a plurality of players play the same game against each other. One or more players may be handicapped to permit players of different skill and knowledge levels to compete against each other.

Another feature provides for wirelessly linking multiple gaming platforms together to enable a team play mode in which a first plurality of players play the same game against a second plurality of players. A skill and/or knowledge level may be obtained for one or more players. The one or more players may then be handicapped so that each player is presented with challenges according to their individual skill and/or knowledge level, thereby allowing players of different skills and/or knowledge level to compete against each other.

Another example, provides a computer-readable medium having one or more instructions defining an interactive educational action game operational on a mobile gaming device, which when executed by a processor causes the processor to: (a) provide an immersive storyline and associated graphics with multiple paths that depend on answers provided by a player to challenges posed throughout the game; (b) associate a character immersed in the storyline with the player, wherein the player plays the role of the character; (c) pose challenges to the player to advance the action game, wherein the challenges test a knowledge and skill level of the player; (d) retain a game record for the player for multiple games; (e) adapt the types of challenges presented to the player according to the game record for the player to hone a weakness; and/or (f) advance the storyline in the action game when the player correctly answers a challenge.

Different characters may be assigned to the player in the storyline as the game progresses. The player may also be allowed to select the storyline from a plurality of storylines.

Another gaming platform may be wirelessly linked to enable the player to compete against a second player. At least one of the player and second player may be handicapped to permit players of game level (e.g., different skill and/or knowledge levels) to compete against each other. The game record for the player may be transferred to a record keeper device.

A method for enhancing gaming experience beyond a mobile gaming device platform is also provided. A user account for a player is created through a website. A unique user key for the player is generated through the website. The unique user key is provided to the player. The player's game information (e.g., progress, scores, milestones, etc.) is tracked on the mobile gaming device. The player's game information is encrypted into a secure string using the user key. The secure string is displayed on the mobile gaming device to the player.

The website may then receive the encrypted string from the player. The website decrypts the secure string using the user key associated with the player to obtain the player's game information. The website then stores the player's game information.

One or more codes may also be encrypted on the website using the user key, wherein the codes are intended to adjust the operation of the player's game. The one or more codes may be provided to the player. The mobile gaming device then obtains the one or more encrypted codes from the player. The one or more codes are decrypted on the mobile gaming device using the user key. The operation of the game is adjusted according to the one or more codes.

### BRIEF DESCRIPTION OF THE DRAWINGS

FIG. 1 illustrates functional components of an interactive educational adventure game according to one implementation.

FIG. 2 illustrates a method for integrating challenges as part of a storyline of an adventure game.

FIG. 3 illustrates a method for handicapping two players of different skill and/or knowledge level so that the challenges presented to each player are approximately equally difficult for each player's knowledge and/or skill level.

FIG. 4 is a block diagram of an electronic device that may be configured to execute an interactive educational adventure game according to one embodiment of the present invention.

FIG. 5 is a flow diagram illustrating of an interactive educational game as may be implemented by software according to one embodiment.

FIG. 6 is a block diagram of a network of electronic devices that operate according to one embodiment of the present invention.

FIG. 7 illustrates one example of a method that extends gaming features from a mobile gaming platform to a centralized website.

FIG. 8 is a block diagram illustrating the flow of information and components for the method described in FIG. 7.

FIG. 9 is a flow diagram illustrating a method for centrally tracking the progress of a plurality of players and providing rewards based on such progress.

FIG. 10 is a flow diagram illustration a method operational on a mobile gaming device and/or game operating thereon for authenticating a player's game score and/or record to a centralized record keeper.

FIG. 11 is a flow diagram illustration a method operational on a centralized website for securely tracking a player's game score and/or record and providing rewards based on player progress.

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

Furthermore, various configurations may be implemented by hardware, software, firmware, middleware, microcode, or a combination thereof. When implemented in software, firmware, middleware, or microcode, the program code or code segments to perform the described tasks may be stored in a computer-readable medium such as a storage medium or other storage means. A processor may perform the defined tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others. The methods disclosed herein may be implemented in hardware, software, or both.

If functions are implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Moreover, a storage medium may represent one or more devices for storing data, including read-only memory (ROM), random access memory (RAM), magnetic disk storage mediums, optical storage mediums, flash memory devices, and/or other computer-readable mediums for storing information.

The various illustrative functions, logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One aspect of the present invention provides interactive educational software games that operate on mobile electronic devices, such as Game Boy® machines, and/or computers. The games include adventure storylines in which a player advances, scores points, or wins by correctly answering questions (e.g., math skills or word construction skills) posed throughout the game. The game gauges a player's skill level for a particular subject (e.g., math, grammar, spelling, science, etc.) to tailor the questions or speed of the game accordingly. As the game progresses, it monitors the player's progress in terms of skill and/or knowledge level and dynamically adjusts the type and/or difficulty of the questions to challenge the player.

A game may be played by a single player or by multiple players against each other. When multiple players play against each other, the game can handicap some players to compensate for differences in skill and/or knowledge levels. That is, based on each player's profile and/or development history, the game may adjust the questions or challenges for each player so that all players are approximately equally challenged even though the difficulty level of their questions may be different.

Another aspect of the invention provides an offline authentication method to facilitate providing extended features to electronic games. A game may be played on a mobile gaming device having limited networking and/or communication capabilities. A centralized website enables a player to register offline and obtain a unique user key. The player then provides the game with the unique key. The game uses the unique key to encrypt the player's progress, records, and other game information into a string. The encrypted string is displayed to the player. The player then provides the encrypted string to the website to where it is decrypted (using the user key assigned to the player) and the player's game progress and/or records are logged. When the encrypted string indicates that certain progress has been made or a milestone has been reached, the website may provide the player with a code encrypted using the user key. The code may be provided by the player to the game to unlock certain gaming features and/or adjust the operation of the game.

While various examples of the interactive educational adventure game described herein, a game may focus on one or more subjects, such as math or word skills.

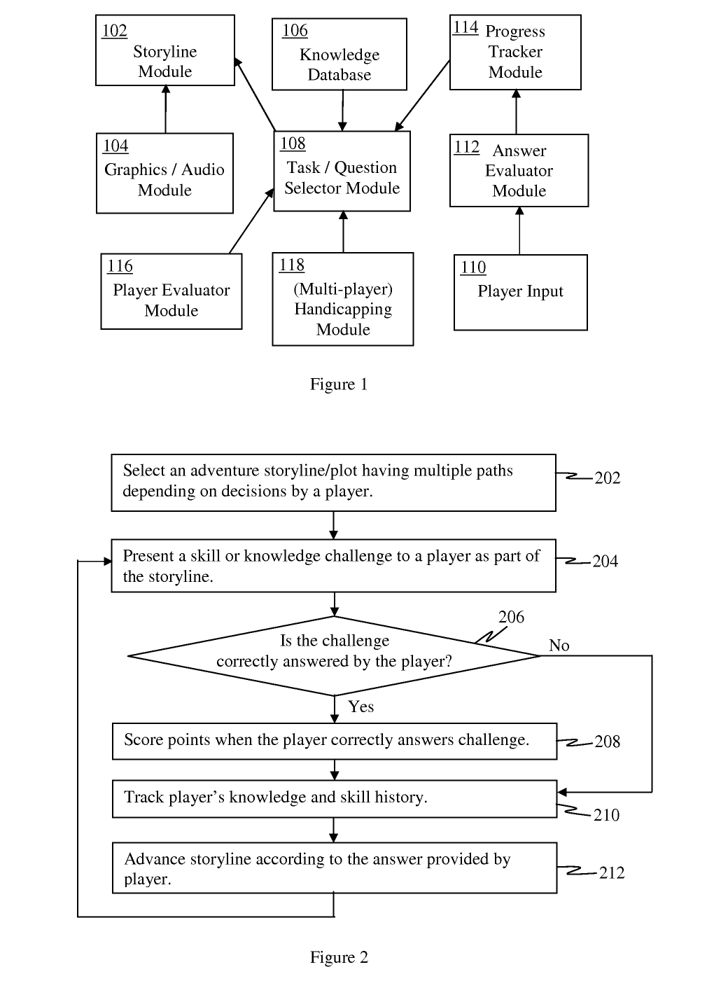

FIG. 1 illustrates functional components of an interactive educational adventure game according to one implementation. A storyline module 102 may include storyline components, such as a plot, characters, places, etc., for one or more adventure stories. For example, the storyline module 102 may include a story about a fictional safari in which a player immerses himself/herself by becoming an animal character that meets and/or interacts with other animal characters while trekking across the safari in pursuit of magical tokens. In another example, the storyline module 102 may include a story about an officer that patrols a galaxy and/or planets to police different life forms, safeguard the planets, and/or repel alien attacks. In this manner, the player is immersed into the storyline of the interactive adventure game.

To support the storyline module 102, a graphics/audio module 104 may provide graphics of scenes and/or characters, as well as audio, related to the storyline. A knowledge database 106 may include a plurality of questions, challenges, puzzles, etc., related to one or more subjects, such as math, language, vocabulary, memorization, grammar, history, etc.

As the storyline of the interactive adventure game progresses, a task/question selector module 108 selects tasks, questions, and/or challenges from the knowledge database 106 and presents them to the player throughout the game.

In response to a selected task, question, and/or challenge, a player input 110 (e.g., answer or response) may be received. The player input 110 may be obtained by an answer evaluator module 112 that determines whether it is correct. A progress tracker module 114 may keep track of the types of tasks and/or questions posed to the player, and correct/incorrect answers provided by the player. This information may then be used by the task/question selector module 108 in selecting the knowledge and/or skill difficulty level of subsequent tasks, questions, and/or challenges.

For example, FIG. 2 illustrates a method for integrating challenges as part of a storyline of an adventure game. An adventure storyline may be selected, where the storyline may have multiple paths depending on decisions by a player 202. A skill or knowledge challenge (e.g., question, puzzle, etc.) is presented to a player as part of the storyline 204. If the player correctly answers the challenge 206, points are scored 208. Based on the answers provided to the challenge, a player's development is tracked 210. The storyline is advanced according to the answers provided by player 212.

Referring again to FIG. 1, a player evaluator module 116 may be used to initially evaluate a starting skill and/or knowledge level of a player. This module may quiz the player before the storyline begins to ascertain strengths and/or weaknesses in the player's skill and/or knowledge. The task/question selector module 108 may then use this information in selecting challenging tasks and/or questions for the player during the adventure game.

In multiplayer mode, a handicapping module 118 may allow two or more players of different skill and/or knowledge level to play against each other in a competitive way. That is, the handicapping module 118 may use each player's progress record to select questions that are approximately equally challenging for each player's skill and/or knowledge level. Thus, while two players may compete against each other, the handicapping module 118 may cause questions of different skill or knowledge difficulty to be presented to different players.

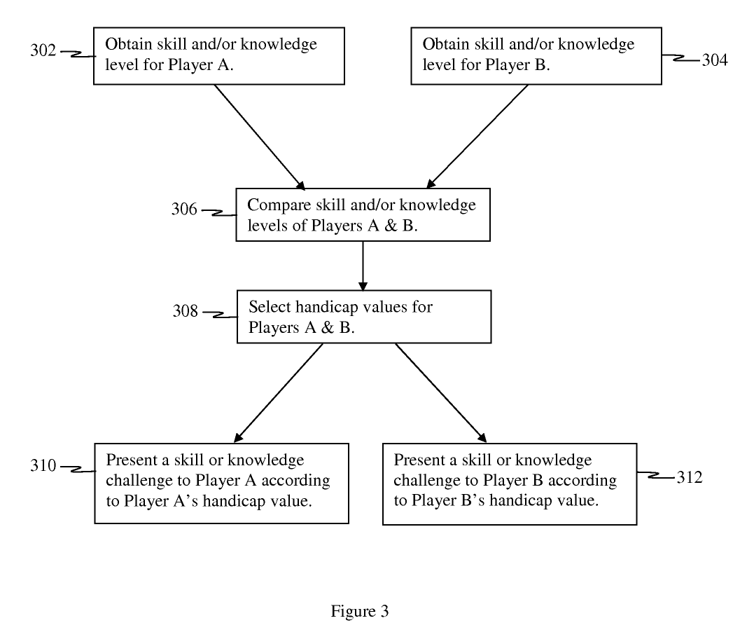

For example, FIG. 3 illustrates a method for handicapping two players of different skill and/or knowledge level so that the challenges presented to each player are approximately equally difficult for each player's knowledge and/or skill level. A skill and/or knowledge level is obtained for Player A 302 as well as for Player B 304. The skill and/or knowledge levels for Players A and B are compared 306 and handicap values are selected for Players A and B 308. The handicap values may be selected so that even if the skill and/or knowledge levels for Players A and B are different, the challenges posed to Players A and B are approximately equally difficult for each player's skill and/or knowledge level. A skill and/or knowledge challenge is presented to each player, according to his/her handicap value 310 and 312.

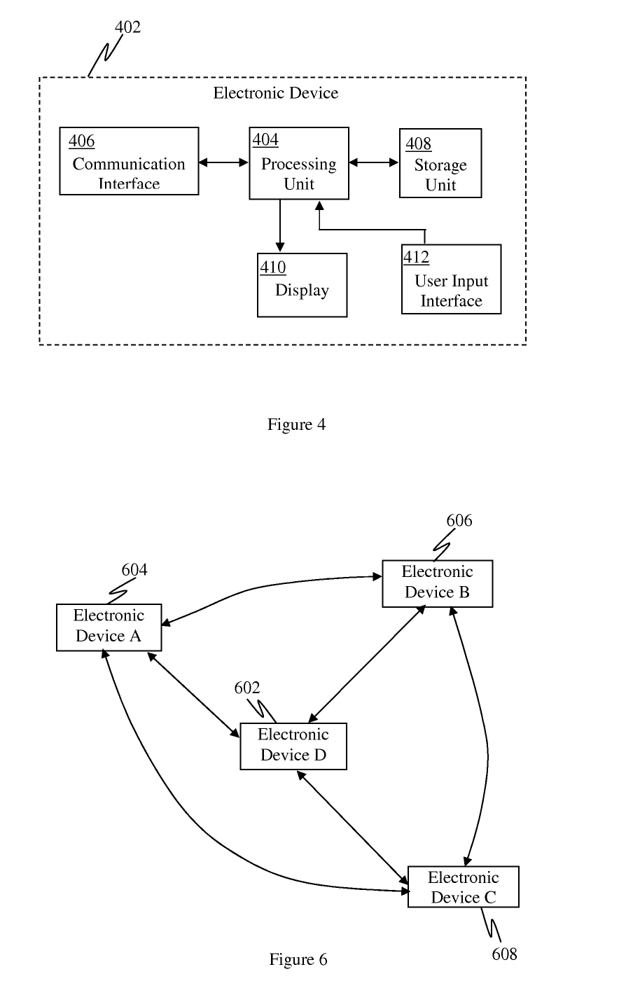

FIG. 4 is a block diagram of an electronic device that may be configured to execute an interactive educational adventure game according to one embodiment of the present invention. The electronic device 402 may include a processing unit 404 coupled to a storage unit 408 that stores data, instructions, and/or commands, which when executed by the processing unit 404 causes the interactive educational adventure game to be run. The storage unit 408 may be an internal storage device, such as a hard drive, flash memory, etc., or a plug-in storage device, such as a cartridge, a USB storage device, etc., capable of storing data, instructions, and/or commands for one or more interactive educational adventure games. The electronic device 402 may be configured to store records for games played by a particular player. This enables the game to track progress by a player, tailor questions to a player's weaknesses/strengths, and increase the difficulty/skill level of questions as a player improves.

Processing unit 404 is coupled to a display 410 through which different scenes, graphics, text, etc., of the interactive game are displayed to a player. A user input interface 412 is also coupled to the processing unit 404 to allow a player to enter answers to questions posed by the interactive game or provide other feedback to the game.

A communication interface 406 may allow the electronic device 402 to communicate with other electronic devices so as to facilitate multiple players to play the interactive game against each other, compete together, and/or compete in teams of two or more players with each team being associated with one or more electronic devices.

In various embodiments, the electronic device may include desktop computers, laptop computers, handheld computers, computing tablets, wireless devices, mobile electronic devices, personal digital assistants, mobile phones, gaming machines (e.g., Game Boy, Play Station), etc.

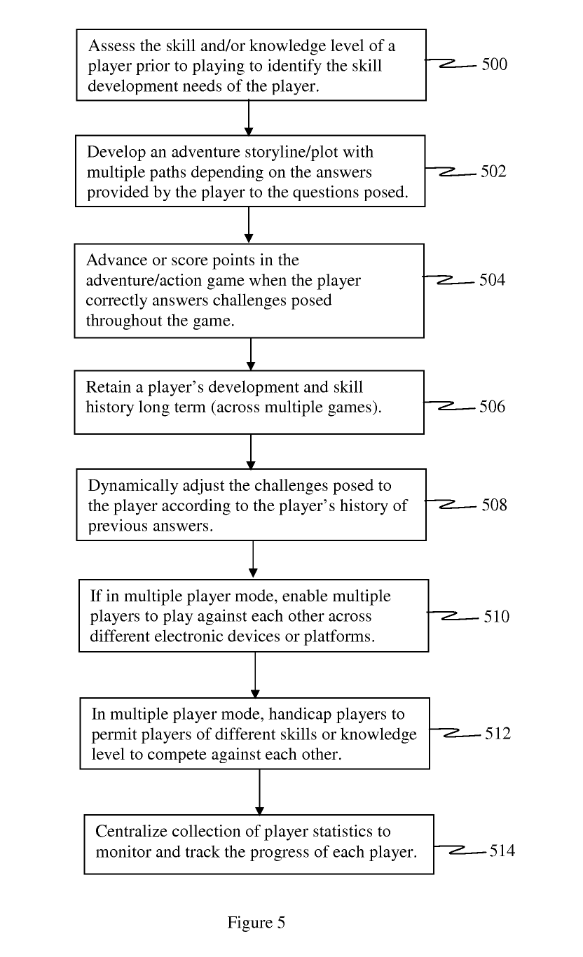

FIG. 5 is a flow diagram illustrating of an interactive educational game as may be implemented by software according to one embodiment. The skill and/or knowledge level of a player may be assessed prior to playing to identify the skill development needs of the player 500. This may be done by performing a short quiz that enables the game to select an initial skill and/or knowledge level for the player. An adventure storyline/plot is developed with multiple paths depending on the answers provided by the player to the questions posed 502. Certain aspects of the storyline may be predefined while other may depend on the skill level of the player. A player advances or score points in the adventure/action game when the player correctly answers challenges posed throughout the game 504. That is, through the game, a player may score points or advance to different parts of the game by correctly answering challenges that may pop-up on the user screen or that are integrated into the actions of the game. Incorrectly answer a challenge or question may cause the player to lose points or be sent back to a previous section of the game.

A player's development and skill history (i.e., gaming record) is retained long term (across multiple games) 506. This feature facilitates tracking the learning curve of a particular player as well as identify problem areas (subjects) that a player may need to strengthen. Moreover, by keeping such skill and/or knowledge history (i.e., gaming record), the interactive educational game can tailor questions to a player's weaknesses/strengths and increase the difficulty/skill level of questions as a player improves.

Additionally, the knowledge and/or skill difficulty of challenges may be dynamically adjusted according to the player's history of previous answers 508. That is, as a player becomes more skilled and/or learns a subject posed in the challenges, the difficulty level of the challenges may be increased accordingly.

In multiple player mode, the game enables multiple players to play against each other across different electronic devices or platforms 510. That is, players on different electronic devices may play against each other. The game also provides handicapping of players to permit players of different skills or knowledge level to compete against each other 512. For instance, this feature may enable a 3^{rd} grader to play against a 4^{th} grader. A first player with a lower skill level is posed challenges appropriate for his/her level while a second player of a higher skill level is posed challenges appropriate to his/her skill level. Thus, while both players may see the same adventure or environment, the challenges or questions are tailored for their own skill level or school grade level.

A centralize collection of player statistics allows monitoring and tracking the progress of each player 514. This feature may enable a teacher to collect statistics for a plurality of students (players) to determine whether they are making progress and identify a student that may be falling behind or that needs help with a particular subject. In various examples, such centralized collection of statistics may be performed by a computer, server, and/or through a website.

FIG. 6 is a block diagram of a network of electronic devices that may operate according to one embodiment of the present invention. These electronic devices 602, 604, 606, and 608 may execute an interactive educational adventure game having one or more features described herein. In one embodiment, the electronic devices 602, 604, 606, and 608 are communicatively linked to each other via wired or wireless links. This enables players operating the electronic devices 602, 604, 606, and 608 to play against each other, play with each other, and/or play as teams. Additionally, an electronic device, e.g., electronic device D 602 may be configured to act as a record keeper device by collecting and storing statistics and records for each of the other devices.

Described herein are a few examples of interactive adventure games illustrating various novel features of the present invention. These examples are illustrative and are not intended to limit the invention to particular storylines, characters, environments, or challenges described. The various features described herein may be implemented in various other types of video games without departing from the invention.

### Example Storylines

A first example provides an interactive word adventure game that is intended to improve a player's word skills.

Word Game Storyline:
Spring has come to the Serengeti and the world is in full bloom. The cycle of life continues as it has for hundreds of thousands of years. But, one day, the most unthinkable thing happens, the Sacred Watering Hole, giver of life to the animals of Serengeti, mysteriously goes dry.
Each of the Five Great Tribes of Serengeti—the Lion, the Baboon, the Elephant, the Giraffe, and the Zebra tribes—have foreseen the coming of this day and have passed down the legend of how, to renew the Sacred Watered Hole. A lone youngling from each tribe must journey far beyond the edge of the Serengeti and retrieve a special Totem. Only when the Five Totems are brought together, will the Sacred Watering Hole be rejuvenated.
Each youngling faces a different journey with unique challenges, and each needs to rely on their special combination of skills to safely and successfully complete the Quest.
When the Totems of all five animal tribes are brought together at the banks of the Sacred Watering Hole, the final mission will be unlocked. All the five Chosen Ones must now join together and journey to the water's source and restart the flow of water.
In this final mission, the player controls all five animals, using them one at a time to overcome increasingly difficult obstacles and, ultimately, restart the water supply flow of the Sacred Watering Hole. The particular skills of each animal will relate to specific challenges presented, fostering concepts both of teamwork and of the unique abilities of each animal while honing word skills.

In this immersive interactive game, five different animals (e.g., Mfalme the lion, Ujinga the baboon, Epesi the zebra, Mwendo the giraffe, and Imara the elephant) may present five separate ways to play. The game is immersive in the sense that the player plays the part of a character in the storyline. For instance, players may select from five different animals, choosing one that best reflects their personality and/or style of play. A player's actions when playing as one animal may affect the skills tested by the game. For example, playing as one animal is different than another. Zebras may rely on speed and camouflage while elephants may be much stronger than the other animals. Therefore, solving challenges often take different skill sets.

A second example provides an interactive word adventure game that is intended to improve a player's math skills.

Math Game Storyline
The year is 3582. United under a single government, the citizens of Earth have expanded across the cosmos, colonizing new worlds and befriending new alien races. The universe is a happy place until the Kleptoid Empire was discovered. An army of machines from a far-off galaxy, the Kleptoids swarm through the universe stealing technology and conquering other civilizations' worlds.
Highly advanced, the Kleptoids attack with mathematical precision. In fact, they even speak a math-based language. To counter the ever-increasing threat of the Kleptoids, the Union of Planets created an elite fighting force—Math Patrol. Members of Math Patrol fight the Kleptoids by responding to math puzzles and questions.
As soon as cadet (player) joins Math Patrol, his/her skills are tested, and is assigned a tour of duty that best fits his/her abilities. But no one said fighting the Kleptoids would be easy—far from it. The cadet has to use all his/her math skills—and pick up a few new ones along the way—before he/she will be able to push back the Kleptoid threat.
From daring space battles to base defense and covert spy missions, a cadet can, the forces of Earth, and its allies, battle the Kleptoids throughout the universe.

Similarly, other implementations of the invention may be intended to improve other skill sets. A storyline may include various environments, settings, and/or characters that are part of a particular game. The environment and/or storyline for such games may be presented to a player graphically (e.g., images, etc.,), by audio, and/or text. A player's skills are “tested” by weaving and/or integrating challenges into the storyline or adventure game.

Storylines may be designed to stimulate the curiosity of the intended players (e.g., children between 4 and 9 years of age, etc.). Within a game, a player may select from one of a plurality of storylines depending on the player's interests, age, and/or desired skills to be developed.

### Player Skill and Knowledge Level Assessment

Another feature provides for individual player assessment. Prior to playing a game, the skill level and/or knowledge level of each player is individually assessed. Skill level relates to a player's ability to perform certain tasks in an adventure or action game. Knowledge level relates to a player's knowledge of a particular subject. For example, when the player begins a new game, they undergo a series of challenges or questions which ultimately determine that they can undertake the quest. These initial challenges are used to set the difficulty of the game to one of a plurality of skill levels as the player begins his/her first game. As the player continues playing a game, their play is continually assessed and the difficulty level of the game may be reset/adjusted so the game remains challenging and fun.

Once the player has completed the initial challenges, they set off on a quest defined by the storyline for a particular interactive adventure game. A quest may typically include numerous levels and styles of game play. In some implementation, the focus of a game may be more on adventure rather than action. Additionally, a player may encounter more than one type of game play per skill and/or knowledge level. That is, various different types of challenges may be presented to a player at a particular stage of the game.

### Integrated Challenges

Another novel aspect of the invention integrates skill and/or knowledge challenges throughout that interactive adventure/action game. By correctly responding to these challenges, a player is allowed to advance to other levels of play, score points, and/or wins. Challenges may include questions, puzzles, and/or tasks that challenge a player's skills and/or knowledge.

Example Word Game Challenges

Various types of word games, such as comprehension, passwords, phonetics, and/or vocabulary, may be used as challenges that are part of a storyline of a word game. The example challenges below refer to the example word game story line described above, but they may be modified to other storylines.

Side Quests

Along the journey, other animals ask for the player's help. By carefully reading the requests of the other animals and completing these side quests the player able to progress. One goal of such side quests may be to test reading comprehension by making the player perform certain tasks based on what they read. The difficulty level of reading passages and the number of steps within the side quest may vary according to the skill and/or knowledge level of the player, from simple one item requests to multiple-step and more complex tasks.

Vocabulary

Appearing in various forms throughout the main quest, players may have to arrange given letters or terms, such as word prefixes, in order to form words. As players approach the challenge, they are given a spoken word or the definition of a word to spell. In “prefix” levels, the player is given a root word and a definition for the root plus the prefix to be identified. Letters and terms may come in the form of rocks or logs, which the player's character must move. In some cases, sentences or images are given to aid the player.

In one example, a monkey has to leap from rock to rock to select the correct letters in the correct order to spell a word. During easy game play, the rocks are stationary, but with increasing skill level, they move, making jumping much more challenging. Challenging levels may also feature enemies. If the player falls in the water, the word progress is lost and the letters shuffle on the rocks.

In other variations, the character might have to leap or move across logs on a river, for example, while selecting the prefix that best fits the definition given or swing from trees.

Spelling Bees

In another challenge example, a poor little monkey may be trapped in a tree and being attacked by bees. Each bee contains a letter and the monkey has to leap on the bees with the proper letters and in the proper order to spell a given word. In this game, the player takes control of another character. For instance, the monkey, that seems to continually get trapped in various locations (on rocks, in trees, and up vines) and have troubles with a particularly tenacious swarm of bees, takes control of one or more bees to spell a given word.

The player helps the monkey escape the bees by leaping the monkey from one bee to another in the proper sequence to spell a given spoken word. Depending on the severity of the situation, the monkey may have to spell a lot of words to finally evade the bees. Once the player is successful, the monkey runs away crazily.

Phonetics, Rhyming, and Similar Words

Teaches phonetics both by being able to visually identify and translate word sounds as well form word sounds to translate written words into their phonetic parts, rhyming words and synonyms, antonyms and homophones. Some animals the player meets along their journey can only speak in phonetics, which the players must translate what they have said in order to proceed. In other cases, the animal needs the player's character to translate an English word (or words) into phonetics, so that they understand. Occasionally, players may be challenged to select a word that rhymes and makes sense with what the animal had said—finishing their sentences, so to speak. Finally, some animals may challenge the player to identify synonyms, antonyms and/or homophones.

Writing Skills

Occasionally, the player may meet another animal that asks the player to compose a message for it or to report on events that have happened. To accomplish this, a player selects message parts, such as greetings and salutations, icons of subjects and/or verbs to identify other animals and actions, and include grade-level punctuation. Once the messages are composed, the player mails them to the recipient. If the message is incorrect, the correspondence is rejected and the player is not able to advance and/or score points.

Example Math Game Challenges

Various types of math games, such as math operations, code breaking, passwords, phonetics, and/or vocabulary, may be used as challenges that are part of a storyline of a word game. The example challenges below refer to the example word game story line described above, but they may be modified to other storylines.

Recruitment

Once a player finishes The Academy assessment, he/she becomes a Recruit. Recruit missions are designed to further assess the player's skill levels while providing high-energy game play.

Recruit missions immediately thrust the player into the main storyline. The player cannot choose the type of mission they want to play. The storyline, at this point, is that, as soon as the player is out of the Academy, the Kleptoids attack. During the Academy testing, it is discovered that the player has some special “skill” (all players have some “special skill” or another), and the player has been immediately advanced to join the ranks of Math Patrol.

Math Patrol

Once the Recruit missions have been successfully completed, the player formally joins Math Patrol, and the main interface is revealed. Math Patrol Rangers operate a lot like Texas Rangers or Jedi Knights—kind of a “one person threat response” organization. To that end, once a player moves beyond the Recruit stage, the player can select from a variety of missions—some harder, some easier—and move through the game via multiple game branches. Each mission may involve one or more challenges that are designed to allow a player to fulfill the mission.

Asteroid

Unlike the classic game of asteroids, this game operates bit in reverse. The asteroids stay relatively stationary (e.g., they move but much more slowly than in the classic asteroids game) and the ship moves through them as if caught in a large maze.

At more advanced levels, the Kleptoids have seeded the asteroids with technology that makes the “answers” jump at regular intervals, forcing players to act quickly.

Math questions appear on the screen, one at a time, and an answer is chosen by destroying the correct asteroid. Answer Asteroids are spread out across the map. Once has determined the correct answer, the player has to locate and destroy an asteroid containing the correct answer.

Base Defense

Math questions appear on the screen, one at a time, and must be answered correctly by destroying the correct incoming missile or asteroid before it reaches the base station.

Scramble

The player selects a mission to get to “XYZ” planet, moon, asteroid, or to infiltrate a Kleptoid stronghold. The player then flies a ship (left to right on the screen) through a planet landscape. Kleptoid ships must be avoided (they “hover” in a particular area of the screen) or shot down. Some Kleptoid ships are carrying Bonuses (which can be good or bad). In addition to Kleptoid ships, players need to refuel during missions, as well as navigate Shields and collect Blaster Upgrades.

Math questions appear on the screen, one at a time, and must be answered correctly to complete certain requirements of the mission:
Battles—Kleptoid ships come in patrols (3 to 7 ships), and the player must shoot the ships that correspond to the answer for the math problems given. If the incorrect ship is shot, it fires back at the player. Ships may take more than one problem/shot to destroy, and some ship may retreat before the end of the battle.
Refueling—Fuel runs out quickly, and it is impossible to complete a mission without refueling regularly.
Shields—To penetrate the defense Shields that block the player's path, they must fly through the slots corresponding with the given problem.

Code

Code challenges are missions that provide a break from the action missions and require players to use their brains and deductive skills. In “Code” missions, the player must solve a selection of puzzles to crack a secret message. Each problem reveals a word in a message. Revealing the entire message opens up a new mission. This is a mission that provides a break from the action missions and requires players to use their brains and deductive skills. Each problem reveals a word in a message. Revealing the entire message opens up a new mission.

Time

A time challenge involves action missions where players must shoot enemies which correspond to a given analog time. The objective is to teach analog time by having players make identifications between a given analog time and enemies with the corresponding digital equivalent. In the majority of time missions, players identify the enemies that correspond with the given analog time. In other time missions, players must perform a specific action at a specific time or at certain intervals. In some missions, it's a single task, in others, it's a task that's repeated “every seven minutes” or the like.

Count Doku

Plays like traditional game of Soduko—shapes or numbers must be placed in an order both horizontally and vertically where each shape/number is used once and none are repeated. The player selects shapes or numbers and places them within the grid to complete the sequence. The game progresses in difficulty from a 2×2 grid with shapes to a 9×9 grid with numbers. There are no math problems, just teaching logic and honing visual and deductive abilities.

Comparison

The player must make comparisons between numbers, visual groups, fractions, time, money, and math equations. It teaches and assesses concepts of similar and dissimilar values using differing expressions—numbers versus a visual group, for example. Tests the player's concept of value and differing expressions, such as: 5, 12−7, 20/4 and a set of 5 objects are all equal values.

Math Memory

The traditional game of memory given a differing expression twist. Players must match tiles such as 3×7 and 30-1. Content includes math equations, visual groups, fractions, time, and money. The objective is to clear all the cards and reveal an image or clue beneath. The player selects one tile and must turn over another tile to reveal its equivalent. For tiles that “hold” math equations, the equation is displayed on screen separate from the tile. When a perfect match is made, the tiles are removed to display part of the image or code beneath.

Space Dodge

Based on dodge ball, the player races other players or the computer to the correct “answer balls” which can them be fired at the opposing players. The objective is to eliminate the opposing players/enemies by destroying their ships. The player faces off against other players or computer-controlled Kleptoid ships. A math problem is given, and the first ship to “grab” the correct answer to the problem takes control of it. By pressing a button, the problem can be fired at the opposing ships. “Answer balls”, however, degrade in strength over a period of seconds, and after however several seconds, the answer ball vanishes. New questions appear as soon as a player successfully obtains an answer ball. Colliding with incorrect answers or other obstacles causes damage to the ship.

### Content and Difficulty Level Advancing

Throughout a game, a player may be continually assessed for both content level (e.g., knowledge) and game play difficulty level (e.g., skill). For example, if a player scores 90% or better on a subject over two consecutive levels, the next level advances a skill grade for that subject. If, for example, a player scores less than 60% in one level or less than 75% over two levels, the skill grade level of the content may be reduced in the next level.

According to one feature, approximately 20% of questions presented may be review (previously mastered subjects or levels) and 5% may be challenge questions (beyond the current level, up to the maximum).

### Adaptive Questioning

Adaptive questioning adjusts the difficulty level of challenges to hone a player's weaknesses. A player self-assessment, goals and rewards provide inspiration to continue playing. Additionally, multiple story paths make the interactive adventure game a unique experience tailored to every player.

### Playing the Game—Single-Player Mode

The different game types are played in turn to complete missions, such as for example, flying to another planet while challenged with scramble problems and, once the player reaches the planet, the players defends a colony there from Kleptoid attack by answering challenges while playing Missile Command, etc.

Between missions, players can upgrade their ships, by using money earned from successfully completing missions, purchase travel to far off planets (avoiding the missions that have them flying there), and manage the component upgrades and artifacts they have earned. Players can also save and load games from a Command center.

One main advantage of playing the single-player adventure is that only through the single-player game can players unlock special skills that they can use in the multiplayer game. Skills come in the form of alien artifacts and include items like the “Time Stop” which allows the player to freeze all other players for 30 seconds while they try to answer the problem.

### Playing the Game—Multi-Player Mode

Multiplayer mode presents two types of games Quick Challenges or Campaign Mode.

Quick Challenges—pits players against each other in single round challenges. Up to four players may be supported (depending on the game) and rounds are cumulative, so players can play for just one round or until they have a champion. Games may be variants of the games presented in the single player games (such as Spelling Bees) or stand alone mini games (like Word Checkers).

In one-on-one mode all players battle all other players while in team play two players may be Math Patrol and two players may be Kleptoids.

Campaign Mode—Players are given a series of back-to-back levels, with differing game play, that have a central story arch. Whichever player scores the best overall on all the levels combined is the winner.

Cooperative Missions—Unique side quests supporting up to four players working together towards victory. In the cooperative missions, both the in-map challenges and the content-based games rely heavily on the various strengths of the payers and their chosen characters.

Bonuses—Prior to playing a multiplayer game, players can pick four bonuses from their collection that they wish to use in the game. Bonuses may only be used once, so players must be cautious about when to use them.

Multiplayer Ladder—When players combat each other in multiplayer mode, all their score are saved to each cart. When players join new multiplayer games, all of the stored scores on their carts are exchanged, creating a huge ladder and a community among players.

In order to avoid player name conflicts, when a player joins a multiplayer game, they are asked to create a name for themselves. This name is checked against all other names on the other carts (perhaps after the score sync).

### Tournament Play

One aspect of the invention provides for record-keeping of a player's gaming history (e.g., scores, accomplishments, etc.) during single and/or multiplayer modes. This gaming history may be downloaded from an electronic device on which the user plays the game. The information found in the gaming history can then be used to rank players and create tournaments for the highest ranked players. In this manner, players can qualify for online or competition tournaments where they compete against other players (in local or remote locations) in events based on one or more of the challenges. In one example, the gaming history may be provided to a centralized website (i.e., record keeper) by a player in an encrypted form that inhibits tampering with the player's score.

Method for Tracking Player Progress Beyond a Mobile Gaming Platform

Many mobile gaming platforms (e.g., devices) that run adventure and/or action games tend to have limited communication and/or networking resources. For example, some devices may be able to communicate with other local mobile gaming devices but do not have the capability to access broader communication networks (e.g., internet). As such, the player's gaming history (e.g., progress, records, and/or milestones) of games played on such devices remain locally stored on the mobile gaming device. This lack of communication resources on mobile gaming devices limit the usefulness, effectiveness and/or features of the game being played.

One aspect of the present invention provides a method for extending the reach of an educational adventure game beyond a mobile gaming platform by providing an authentication method that facilitates transfer of information to and/or from a game operating on a mobile gaming device having limited communication capabilities. By facilitating such secure and/or authenticated data transfer, extended features for games operating on the mobile gaming device are made possible.

In one example, data transfers to/from games running on a mobile gaming device are facilitated by a website (operating on a server or computer). The website may facilitate a built-in authentication mechanism for educational adventure games operating on network-limited gaming devices. A network-limited gaming device may be a mobile gaming device not communicatively coupled to other gaming devices. The website facilitates centralized collection of player information and/or score from a gaming device and provides delivery of extended game features.

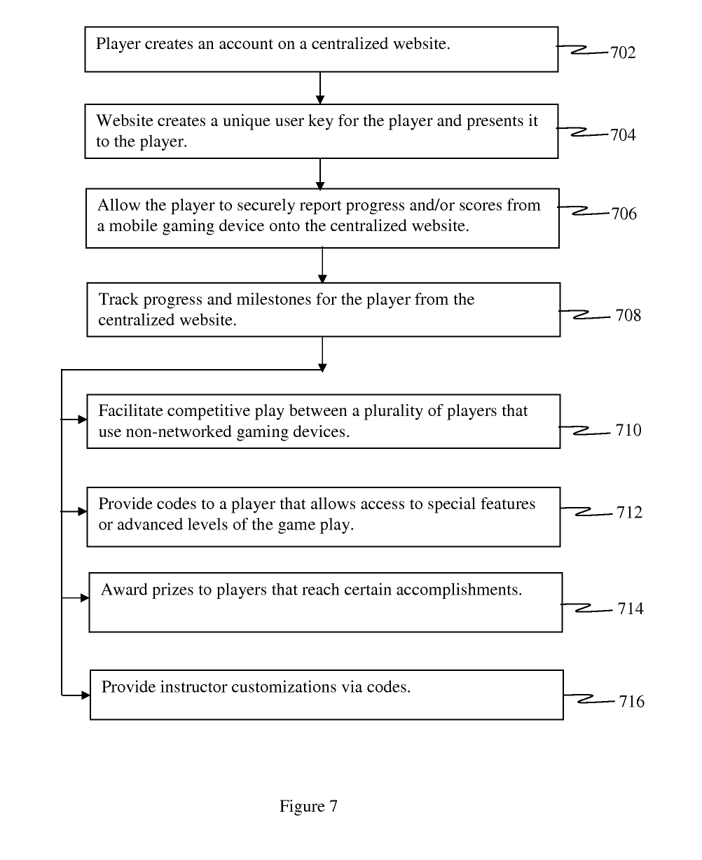

FIG. 7 illustrates one example of a method that extends gaming features from a mobile gaming platform to a centralized website. A player may create an account on a centralized website 702. This may be done via a computing device separate from the mobile gaming platform (which may not have network access to the website). The website may then create a unique user key for the player and presents the user key to the player 704. The website allows the player to securely report progress and/or scores from a mobile gaming device onto the centralized website 706. For example, the user key may be used by the game (operating on the mobile gaming platform) to encrypt the player's progress, scores, record, history, etc. and provided them as one or more encrypted strings that the player may then enter into the website to log the information encrypted in the strings. Such secure reporting system may prevent a player from reporting a false score or reporting the score from a different player into their own account. In this manner, the centralized website securely tracks and authenticates the player's progress and/or milestones 708.

Having collected accurate and authenticated player records, the website may be used to provide extended features to the game running on the mobile gaming platform. These extended features may be provided even if there is no direct or networked communications between the website and the mobile gaming platforms.

In one example, the centralized website may facilitate competitive play between a plurality of players that use non-networked gaming devices 710. For instance, by collecting scores, records, and/or other information from a plurality of players playing the same game (on different mobile gaming devices) the website is capable of comparing scores and picking a winner. Additionally, the website may provide players in a “tournament” with a code that players can enter (as the tournament starts) into their mobile gaming device to trigger a set of challenges (e.g., questions, skill level, knowledge level, etc.) in their games during the tournament. In this manner, the website operator may guarantee that all players in a tournament are posed the same challenges, skill difficulty, and/or knowledge difficulty during the tournament. Alternatively, since the website tracks the progress and/or milestones (e.g., skill and/or knowledge level) for the players, it may know the strengths and/or weaknesses of each player. The website may thus provide tournament codes to each player that are intended to cause handicapping of their games to allow a competitive tournament between players of different skill levels.

In another example, having tracked a player's progress, the website may provide the player a code that unlocks advanced skill and/or knowledge challenges or special gaming features 712. A player may receive a code that is encrypted using his/her own user key so that other players (who have been assigned different user keys) cannot use the code in their gaming devices.

Yet another implementation allows the website to award prizes to players based on certain accomplishments 714 (e.g., their individual progress, milestones, and/or scores, etc.). Such prizes may include discounts for future games, new games, among other incentives.

Another feature may allow an instructor to customize the type of questions that a particular player should be asked by the game 716. For example, the instructor may indicate the type of desired skill and/or knowledge challenges to the website. The website then provides a customized code to the player which the player enters on the mobile game station to tailor the game accordingly. The instructor may be able to access the website, view player records (e.g., scores, progress, etc.), and assign new tasks or game levels.

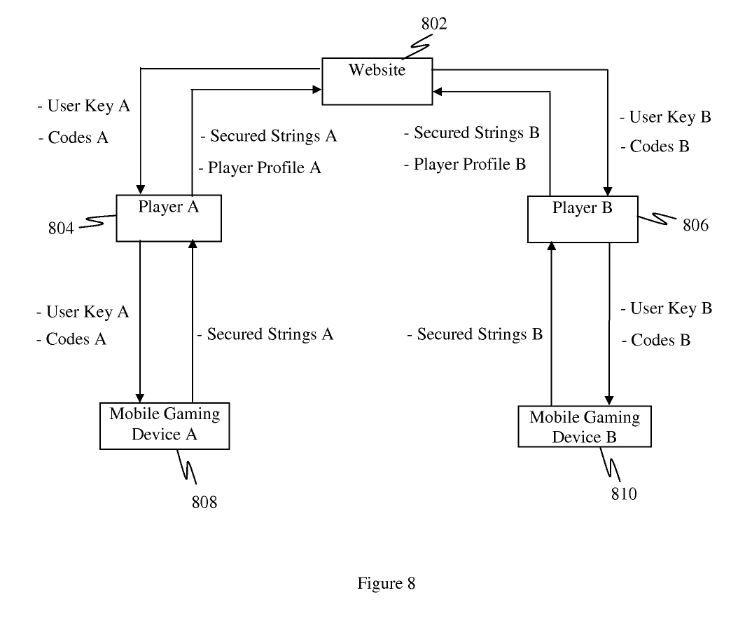

FIG. 8 is a block diagram illustrating the flow of information and components for the method described in FIG. 7. A centralized website 802 is used by players A 808 and B 806 to register and/or setup an account. As a result of registering, players A and B get unique user keys A and B, respectively. Players A 804 and B 806 enter their respective user keys into their respective mobile gaming devices A 808 and B 810, respectively. That is, the game(s) operating on the mobile gaming devices A 808 and B 810 are provided with the user key. As a result, the game(s) operating on mobile gaming devices A 808 and B 810 are configured to encrypt player information using the user key and provide it as a secured (e.g., encrypted) string A and B, respectively, to the players. Encrypting player information (.e.g., records, progress, etc.) with the user key may include using a function such that a hacker is inhibited from decrypting the string even if the user key is known. The players A 804 and B 806 may then enter the secured strings A and B, respectively, into the website to log their progress and/or scores.

The website can use a user key associated with a player to authenticate a secured string provided by the player. If the string provided by a player is valid (i.e., it is correctly authenticated) then the website logs the player information. Depending on a player's progress and/or scores, one or more codes may be provided by the website 802 to players A 804 and/or B 806. Such codes may be encrypted by the user key. The player can read or obtain the codes from the website and manually enter them into the mobile gaming device to trigger one or more features. The website may encrypt the codes using the unique user key for each player so that the user key associated with one player cannot be used by a different player. That is since each player's mobile gaming device has a different user key, an encrypted code cannot be decrypted by a mobile gaming device having a different user key. The secured strings and codes may be n-digit numbers and/or n-character strings.

In an alternative implementation, a code provided by the website may be a sequence of graphical icons that the player may select from an interface on the mobile gaming device to enter the code.

In this manner, player records may be securely obtained from players and authenticated by the website 802 while player-specific codes may be provided to each player to trigger special features on the games operating on the mobile gaming devices. Additionally, since a player registers with the website, awards or prizes may be sent to players that reach certain scores or achieve a minimum level of improvement.

Method for Offline Recording and Authentication of Records

Another aspect provides a secure way for centrally storing and tracking the progress of a plurality of players. In order to authenticate the identity of the player and/or accuracy of the information (e.g., game scores, etc.) reported by the player to the centralized website, a secure method is provided. For instance, a centralized website may collect scores and/or progress information for a plurality of players and award prizes, discounts, and/or unlock gaming codes (e.g., to provide additional difficulty levels or gaming environments for a particular educational game).

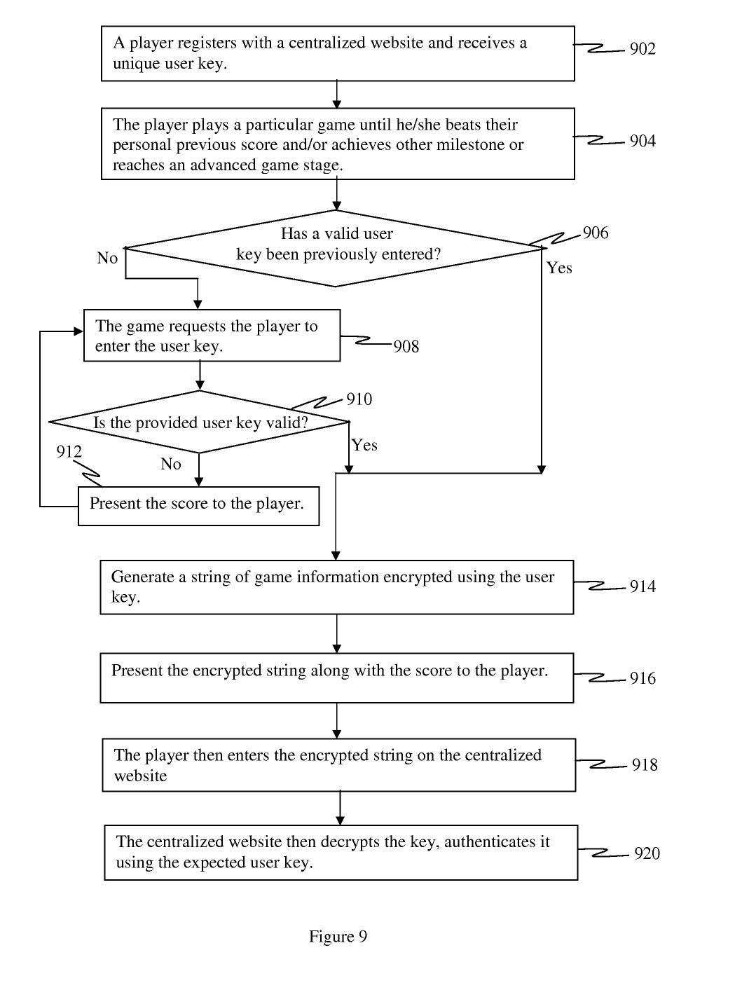

FIG. 9 is a flow diagram illustrating a method for centrally tracking the progress of a plurality of players and providing rewards based on such progress. Upon purchasing a game and/or when requested by the game (e.g., played on a mobile gaming device), a player may register with a centralized website (e.g., through independent network channels and receives a unique user key 902. The player may play a particular game until he/she beats their personal previous score, achieves a milestone, and/or reaches an advanced game stage 904.

The game determines whether a valid user key has been previously entered 906. If the player has not previously provided a valid user key, the game requests that the player provide a user key 908. The user key may be an n-digit number or n-character string, for example, which is unique to the user. This user key is uniquely associated with a particular player and serves to authenticate a player's scores and/or records. When requesting that the user provide a user key, the game may display a website address or other information that enables and/or instructs the player to obtain the unique user key. That is, the player may create a secure account via a website and, in return, be assigned a unique user key. The player may then provide the unique user key to the game where it is checked to determine its validity 910. That is, the unique user key may include one or more markers or information that the game can use to determine whether it is a valid user key. If the provided user key is not valid, then the game may present the player with his/her score but no other information 912.

If the newly provided user key is valid 910 or a valid user key has been previously entered 906, then game information (e.g., player's score, progress, records, strengths, weaknesses, etc.) may be encrypted into a string using the user key 914. For example, a hash function, one-way function, or other encrypting functions may be employed to secure the string. The encrypting function may be selected such that a hacker is inhibited from decrypting the string even if the user key is known. The encrypted string may be presented to the player along with score information 916, for example.

The player may then enter the encrypted string on the centralized website 918 to record his/her scores. Prior to entering the encrypted string, the player may log into the website by providing some personal information (e.g., a user name and/or password) which it can use to find the previously provided user key for the player. Alternatively, the website may request the user key and string from the player, which it can then use to identify the player. The centralized website then decrypts the key and authenticates it using the expected user key 920. In this manner, the website can determine whether the entered string (and player information therein) was secured by the expected user key (and therefore belongs to the player).

Note that the user key may be used in the manner described above to authenticate a player's records for one game or a plurality of different games. In one example, the games may be stored in a storage media (e.g., cartridge) that plugs into a mobile gaming device. Once a user key is entered on a mobile gaming device, the game in the device stores the user key and associates it with a particular player. From that point forward, the game may track the player's progress and adapt the game and challenges based on the player's history.

The user key and player game records may be maintained in a game cartridge or removable storage device that plugs into a mobile gaming device. Therefore, if the game cartridge is given to someone else, or the player wanted to clear their old user key, the game has an option to remove the user key and/or player records. Such resetting of a game cartridge may also revert the game to an initial state by clearing all saved memory.

In one implementation, a game cartridge may maintain the user key and player game records for a plurality of different players. Players may create a unique player profile (e.g., user name and password or user key) through the mobile gaming device. Subsequently, players would be requested to provide the log-in information on the mobile gaming device at the start of a game. This log-in information is then used to identify a particular player retrieve and update his/her game records on the game cartridge.

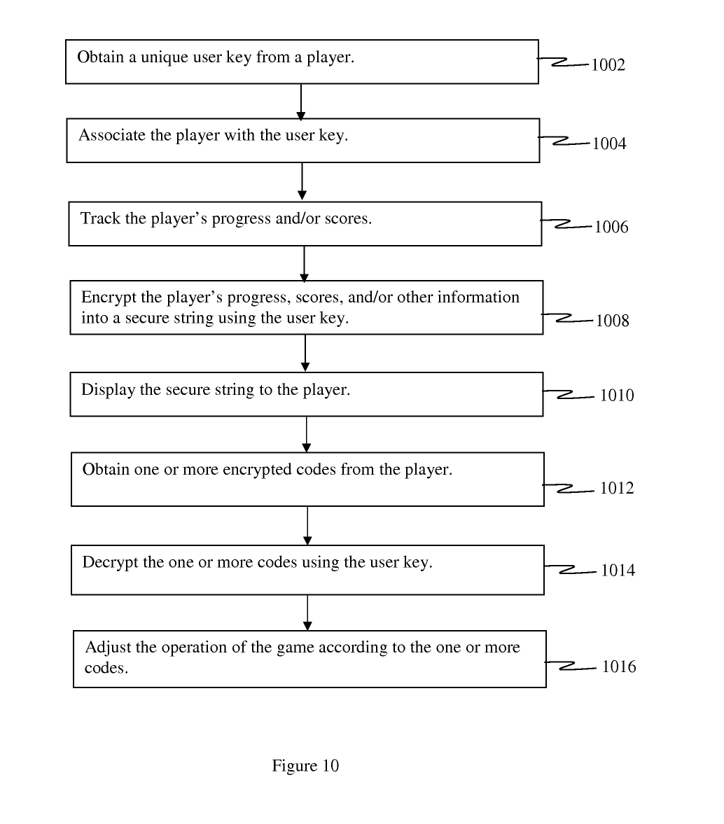

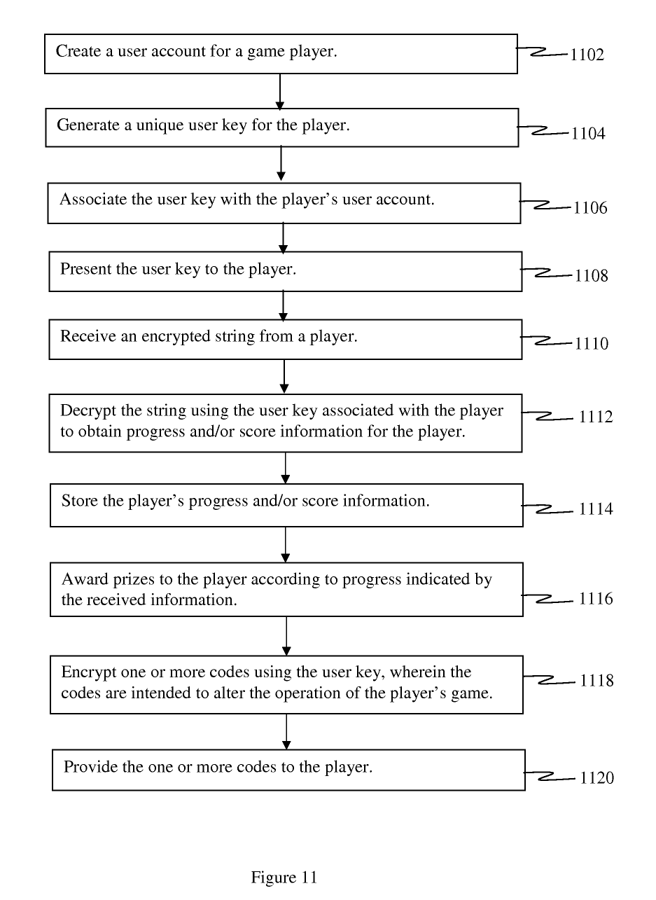

FIG. 10 is a flow diagram illustration a method operational on a mobile gaming device and/or game operating thereon for authenticating a player's game score and/or record to a centralized record keeper. A unique user key is obtained from a player 1002. The unique user key may be obtained from a centralized website when a player creates an account or registers. The player is associated with the user key 1004. The game then tracks the player's progress and/or score 1006. The player's progress, scores, and/or other information may be encrypted into a secure string using the user key 1008. The secure string is then displayed to the player 1010.

Additionally, one or more encrypted codes may also be obtained from the player 1012. Such codes may be generated by the centralized website based on the player's progress and/or scores, as reported by the player entering the secured string (generated by the game) to the centralized website. The code is decrypted by the game using the user key 1014. The game may then alter the operation of the game according to the one or more codes 1016. For example, a code may place the game into a special “tournament” mode (or other mode). Or a code may cause advanced stages of the game to be accessible to the player. Additionally, the codes may indicate the types of skill and/or knowledge challenges that the game should present to the player during the game.

FIG. 11 is a flow diagram illustration a method operational on a centralized website for securely tracking a player's game score and/or record and providing rewards based on player progress. The centralized website may operate on a computer or server that hosts the website. A game player creates a user account via the website 1102. This may be done when the player starts playing a game on a mobile gaming device or when the player purchases the game, for example. The website generates a unique user key for the player 1104 and associates the user key with the player's user account 1106. The user key may be presented to the player 1108.

The website may receive an encrypted string from a player 1110. That is, the player may obtain the encrypted string from the game and enter the string into the website to log his/her progress. The encrypted string may contain the player's progress and/or scores for the game. The website decrypts the string using the user key associated with the player to obtain progress and/or score information for the player 1112. The website then stores the player's progress and/or score information 1114. Prizes may be awarded to the player according to progress indicated by the received information 1116.

The website may also encrypt one or more codes using the user key, wherein the codes are intended to alter the operation of the player's game 1118. The one or more codes are then provided to the player 1120. The player may enter the codes into the game on the mobile gaming device to adjust the operation of the game accordingly.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Additionally, it is possible to implement the invention or some of its features in hardware, programmable devices, firmware, software or a combination thereof. The invention or parts of the invention may also be embodied in a processor readable storage medium or machine-readable medium such as a magnetic, optical, or semiconductor storage medium.

1. A computer-readable medium having one or more instructions defining an interactive educational game operational on mobile gaming device, which when executed by a processor causes the processor to:
assess a starting game level for a player;
provide an immersive storyline with multiple paths that depend on answers provided by the player to challenges posed throughout the game;
pose a plurality of challenges to the player, wherein the challenges are related to an academic subject matter;
advance the storyline in the interactive game according to the player's answers to the challenges; and
retain a game record for the player for multiple games based on the challenges posed to the player.

2. The computer-readable medium of claim 1, wherein the player assumes the role of a character immersed in the storyline.

3. The computer-readable medium of claim 1 wherein the challenges are related to at least one of mathematics, vocabulary, grammar, or logic.

4. The computer-readable medium of claim 1 having one or more instructions which when executed by a processor causes the processor to further:
select different paths of the storyline according to the correctness of the answers provided to the challenges posed.

5. The computer-readable medium of claim 1 having one or more instructions which when executed by a processor causes the processor to further:
adjust the difficulty level of the game according to the game record for the player.

6. The computer-readable medium of claim 1 having one or more instructions which when executed by a processor causes the processor to further:
adapt the types of challenges presented to the player according to the game record for the player to hone a weakness, wherein the game record includes skill and knowledge information about the player.

7. The computer-readable medium of claim 1 having one or more instructions which when executed by a processor causes the processor to further:
assign different characters to the player in the storyline as the game progresses.

8. The computer-readable medium of claim 1 having one or more instructions which when executed by a processor causes the processor to further:
wirelessly link multiple gaming platforms together to enable a multi-player mode in which a plurality of players play the same game against each other.

9. The computer-readable medium of claim 8 having one or more instructions which when executed by a processor causes the processor to further:
handicap one or more of the plurality of players to permit players of different skill and knowledge levels to compete against each other.

10. The computer-readable medium of claim 1 having one or more instructions which when executed by a processor causes the processor to further:
wirelessly link multiple gaming platforms together to enable a team play mode in which a first plurality of players play the same game against a second plurality of players.

11. The computer-readable medium of claim 10 having one or more instructions which when executed by a processor causes the processor to further:
obtain a skill and knowledge level record for one or more player;
handicap the one or more players so that each player is presented with challenges according to their individual skill and knowledge level record, allowing players of different skill and knowledge levels to compete against each other.

12. The computer-readable medium of claim 1 having one or more instructions which when executed by a processor causes the processor to further:
obtain a unique user key from the player;
associate the player with the user key;
encrypt the player's game record into a secure string using the user key; and
display the secure string to the player.

13. The computer-readable medium of claim 13 having one or more instructions which when executed by a processor causes the processor to further:
obtain one or more encrypted codes from the player;
decrypt the one or more codes using the user key; and
adjust the operation of the game according to the one or more codes.

14. A computer-readable medium having one or more instructions defining an interactive educational game operational on a mobile gaming device, which when executed by a processor causes the processor to:
obtain a unique user key from a player;
pose challenges to the player to through the interactive game, wherein the challenges test a knowledge level of the player;
retain a game record for the player for multiple games;
adjust the types of challenges presented to the player according to the game record for the player to hone a weakness;
encrypt the player's game record into a secure string using the user key; and
display the secure string to the player.

15. The computer-readable medium of claim 14 having one or more instructions which when executed by a processor causes the processor to further:
obtain one or more encrypted codes from the player;
decrypt the one or more codes using the user key; and
adjust the challenges presented to the player according to the one or more codes.

16. The computer-readable medium of claim 14 having one or more instructions which when executed by a processor causes the processor to further:
wirelessly link to another gaming platform to enable a the player to compete against a second player.

17. The computer-readable medium of claim 16 having one or more instructions which when executed by a processor causes the processor to further:
handicap at least one of the player and second player to permit players of different skill and knowledge levels to compete against each other.

18. A method for enhancing gaming experience beyond a mobile gaming device platform, comprising:
creating a user account for a player through a website;
generating a unique user key for the player through the website;
providing the unique user key to the player;
tracking the player's game information on the mobile gaming device;
encrypting the player's game information into a secure string using the user key;
display the secure string on the mobile gaming device to the player;
receiving the encrypted string on the website from the player;
decrypting the secure string using the user key associated with the player to obtain the player's game information; and
storing the player's game information on the website.

19. The method of claim 18 further comprising:
encrypting one or more codes on the website using the user key, wherein the codes are intended to adjust the operation of the player's game; and
providing the one or more codes to the player.

20. The method of claim 19 further comprising:
obtaining the one or more encrypted codes on the mobile gaming device from the player;
decrypting the one or more codes on the mobile gaming device using the user key; and
adjusting the operation of the game according to the one or more codes.
